(19) United States
(12) Patent Application Publication
(10) Pub. No.: US 2017/0078824 A1
(43) Pub. Date: Mar. 16, 2017

(54) ELECTRONIC APPARATUS, AUDIO SYSTEM AND AUDIO OUTPUT METHOD

(71) Applicant: SAMSUNG ELECTRONICS CO., LTD., Suwon-si (KR)

(72) Inventor: Jae-cheol HEO, Suwon-si (KR)

(73) Assignee: SAMSUNG ELECTRONICS CO., LTD., Suwon-si (KR)

(21) Appl. No.: 15/233,191

(22) Filed: Aug. 10, 2016

(30) Foreign Application Priority Data
Sep. 11, 2015 (KR) 10-2015-0128847

(51) Int. Cl. H04S 7/00; H04S 3/00; G06F 3/16; H04R 5/02

(52) U.S. Cl. CPC H04S 7/308; H04R 5/02; H04S 3/008; G06F 3/165; H04R 2420/07; H04S 2400/01

(57) ABSTRACT

An electronic apparatus includes at least two internal speakers; a communicator configured to communicate with at least one external speaker; and a processor configured to, in response to a multi-channel audio signal being received, respectively assign different channel signals included in the multi-channel audio signal to the at least two internal speakers and the at least one external speaker so that the different channel signals are output through the at least two internal speakers and the at least one external speaker.

### CROSS-REFERENCE TO RELATED APPLICATION

This application claims priority from Korean Patent Application No. 10-2015-0128847, filed on Sep. 11, 2015, in the Korean Intellectual Property Office, the disclosure of which is incorporated herein in its entirety by reference.

### BACKGROUND

1. Field

Apparatuses, systems, and methods consistent with exemplary embodiments relate to an electronic apparatus, an audio system and an audio output method, and more particularly to an electronic apparatus for a multi-channel audio output, an audio system and an audio output method.

2. Description of the Prior Art

As electronic technology develops, various techniques for providing three-dimensional sound to a user are developed. A multi-channel sound output apparatus is an apparatus for providing three-dimensional sound to a user by outputting sound in various directions.

However, in a related art, a sound output apparatus plays sound according to an audio output type of the sound output apparatus. For example, if a sound output apparatus is a stereo output type, stereo sound is played and if the sound output apparatus is 5.1 channel output type, 5.1 channel sound is played.

Therefore, even though a sound output apparatus is connected to an electronic apparatus, sound only can be played according to an audio output type of the sound output apparatus and a higher channel sound cannot be provided. For example, even if an electronic apparatus of a stereo output type is connected with an audio output apparatus of 2.1 channel type, it is impossible to realize 4.1 channel sound.

Also, when an electronic apparatus and an audio output apparatus are connected, since sounds of the electronic apparatus and the audio output apparatus overlap, there is inconvenience that a user should turn off the electronic apparatus's sound or the audio output apparatus's sound.

Accordingly, when an audio output apparatus is connected to an electronic apparatus which cannot provide a multi-channel sound, it is desirable to provide multi-channel sound or sound from a channel greater than an audio channel which the audio output apparatus can embody.

### SUMMARY

Exemplary embodiments are related to an electronic apparatus, an audio system and an audio output method which can control different channel signals included in a multi-channel audio signal to be outputted from different speakers.

According to an exemplary embodiment, there is provided an electronic apparatus, including: at least two internal speakers; a communicator configured to communicate with at least one external speaker; and a processor configured to, in response to a multi-channel audio signal being received, respectively assign different channel signals included in the multi-channel audio signal to the at least two internal speakers and the at least one external speaker so that the different channel signals are output through the at least two internal speakers and the at least one external speaker.

The apparatus may further include an audio processor configured to process the multi-channel audio signal, and the processor may separate the different channel signals from the multi-channel audio signal by decoding the multi-channel audio signal, mix at least two different channel signals among the separated different channel signals based on a number of the at least two internal speakers and the at least one external speaker, and assign the mixed signal to the at least two internal speakers and the at least one external speaker.

The processor may mix at least two different channel signals among the separated different channel signals based on information on an audio output type of the at least two internal speakers and information on an audio output type of the at least one external speaker, and assign the mixed signal to the at least two internal speakers and the at least one external speaker.

The processor may provide a user interface (UI) for selecting at least one of the audio output type of the at least two internal speakers and the audio output type of the at least one external speaker.

The processor may provide an UI including at least one piece of information on a providable audio output environment based on information on an audio output environment of the at least two internal speakers and information on an audio output environment of the at least one external speaker, mix at least two different channel signals among the separated different channel signals based on the selected audio output environment, and assign the mixed signal to the at least two internal speakers and the at least one external speaker.

The multi-channel audio signal may include a front channel signal, a center channel signal and a rear channel signal, and the processor may assign the front channel signal and the center channel signal to the at least two internal speakers, and assign the rear channel signal and the center channel signal to the at least one external speaker.

The at least one external speaker may include two or more speakers, and the processor may assign, to a right speaker and a left speaker which are included in the at least two internal speakers, a signal in which a left-front channel signal and the center channel signal are mixed and a signal in which a right-front channel signal and the center channel signal are mixed, and assign, to a right speaker and a left speaker which are included in the at least one external speaker, a signal in which a left-rear channel signal and the center channel signal are mixed and a signal in which a right-rear channel signal and the center channel signal are mixed.

The communicator may communicate with the at least one external speaker in a wireless communication method by using time division multiplexing, which synchronizes wireless signal output time.

The communicator may communicate with the at least one external speaker in a wired communication method, and the processor may assign the multi-channel audio signal to the at least one external speaker based on information on a terminal which is connected to the at least one external speaker.

According to an exemplary embodiment, there is provided an audio system including: an electronic apparatus including at least two first speakers; and an audio output apparatus that communicates with the electronic apparatus and includes at least one second speaker, wherein the electronic apparatus is configured to, in response to a multi-channel audio signal being received, respectively assign different channel signals included in the multi-channel audio signal to the at least two first speakers and the at least one second speaker so that the different channel signals are output through the at least two first speakers and the at least one second speaker.

The electronic apparatus may separate the different channel signals from the multi-channel audio signal by decoding the multi-channel audio signal, mix at least two different channel signals among the separated different channel signals based on a number of the at least two first speakers and the at least one second speaker, and assign the mixed signal to the at least two first speakers and the at least one second speaker.

According to an exemplary embodiment, there is provided an audio output method of an electronic apparatus that includes at least two internal speakers and communicates with at least one external speaker, the method including: receiving a multi-channel audio signal; and respectively assigning, in response to the multi-channel audio signal being received, different channel signals included in the multi-channel audio signal to the at least two internal speakers and the at least one external speaker so that different channel signals are output through the at least two internal speakers and the at least one external speaker.

The assigning may include separating the different channel signals from the multi-channel audio signal by decoding the multi-channel audio signal, mixing at least two different channel signals among the separated different channel signals based on a number of the at least two internal speakers and the at least one external speaker, and assigning the mixed signal to the at least two internal speakers and the at least one external speaker.

The assigning may include mixing at least two different channel signals among the separated different channel signals based on information on an audio output type of the at least two internal speakers and information on an audio output type of the at least one external speaker, and assigning the mixed signal to the at least two internal speakers and the at least one external speaker.

The method may further include providing a user interface (UI) for selecting at least one of the audio output type of the at least two internal speakers and the audio output type of the at least one external speaker.

The method may further include providing an UI including at least one piece of information on a providable audio output environment based on information on an audio output environment of the at least two internal speakers and information on an audio output environment of the at least one external speaker, and the assigning may include mixing at least two different channel signals among the separated different channel signals based on the selected audio output environment, and assigning the mixed signal to the at least two internal speakers and the at least one external speaker.

The multi-channel audio signal may include a front channel signal, a center channel signal and a rear channel signal, and the assigning may include assigning the front channel signal and the center channel signal to the at least two internal speakers, and assigning the rear channel signal and the center channel signal to the at least one external speaker.

The at least one external speaker may include two or more speakers, and the assigning may include assigning, to a right speaker and a left speaker which are included in the at least two internal speakers, a signal in which a left-front channel signal and the center channel signal are mixed and a signal in which a right-front channel signal and the center channel are mixed, and assigning, to a right speaker and a left speaker which are included in the at least one external speaker, a signal in which a left-rear channel signal and the center channel signal are mixed and a signal in which a right-rear channel signal and the center channel signal are mixed.

The receiving may include receiving the multi-channel audio signal in a wireless communication method by using time division multiplexing, which synchronizes wireless signal output time.

The receiving may include receiving the multi-channel audio signal in a wired communication method, and the assigning may include assigning the multi-channel audio signal to the at least one external speaker based on information on a terminal which is connected with the at least one external speaker.

### BRIEF DESCRIPTION OF THE DRAWINGS

The above and/or other aspects will be more apparent by describing certain example embodiments with reference to the accompanying drawings, in which:

FIG. 1 is a view illustrating a configuration of an audio system according to an exemplary embodiment;

FIG. 2 is a block diagram illustrating a configuration of an electronic apparatus according to an exemplary embodiment;

FIG. 3 is a block diagram illustrating a detailed configuration of an electronic apparatus illustrated in FIG. 2;

FIG. 4 is a block diagram illustrating a configuration of an audio output apparatus according to an exemplary embodiment;

FIGS. 5A and 5B are views for explaining a method of embodying a 5.1 channel audio output from an electronic apparatus of a stereo output type and an audio output apparatus of a 2.1 channel type according to an exemplary embodiment;

FIGS. 6 and 7 are block diagrams for explaining a method of assigning different channel signals from an electronic apparatus to each speaker according to an exemplary embodiment;

FIG. 8 is a view illustrating a user interface (UI) for selecting an audio output type of an internal speaker according to an exemplary embodiment;

FIG. 9 is a view illustrating an UI for selecting an audio output type of an external speaker according to an exemplary embodiment;

FIG. 10 is a view illustrating an UI for selecting a terminal connected to an external speaker according to an exemplary embodiment;

FIG. 11 is a view illustrating an UI for selecting a providable audio output environment according to an exemplary embodiment;

FIG. 12 is a view for explaining an audio output method of an electronic apparatus according to an exemplary embodiment; and

FIG. 13 is a view for explaining an audio output method of an electronic apparatus in detail according to an exemplary embodiment.

### DESCRIPTION OF EXEMPLARY EMBODIMENTS

Hereinafter, the exemplary embodiments will be described in detail with reference to the accompanying drawings.

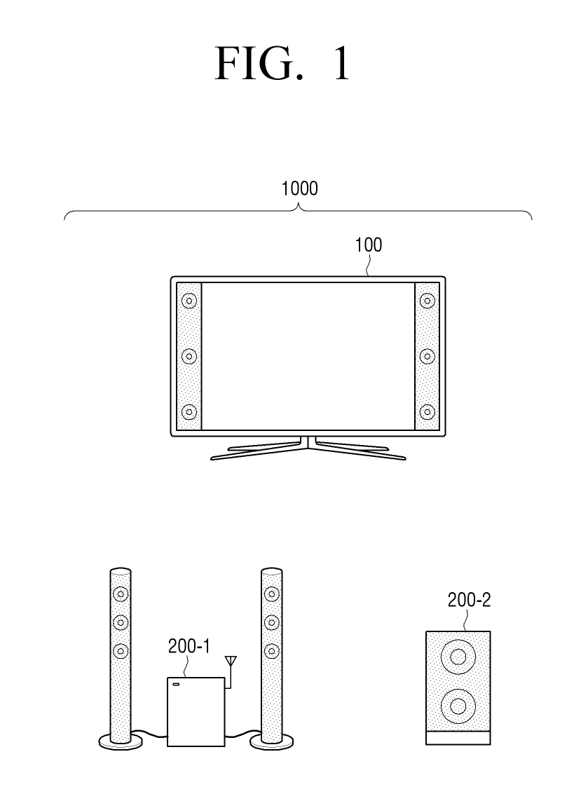

FIG. 1 is a view illustrating a configuration of an audio system according to an exemplary embodiment.

As illustrated in FIG. 1, an audio system according to an exemplary embodiment includes an electronic apparatus 100 and audio output apparatus 200-1 and 200-2.

The electronic apparatus 100 can be embodied as a television (TV) as shown in FIG. 1; however, it is not limited thereto. In other words, the electronic apparatus 100 may be embodied in various apparatuses which can output sound such as a media player, a sound bar, a home theater system (HTS), and the like.

The audio output apparatus 200 is an apparatus for outputting an audio signal received from the electronic apparatus 100, and can make different sounds to be output from each speaker by separating the received audio signal and assigning the audio signal to each speaker.

Specifically, the audio output apparatus 200 may output a rear channel signal and a center channel signal among the different channel signals separated from the electronic apparatus 100. For example, a signal in which a left-rear channel signal and the center channel signal are mixed may be outputted from a left speaker and a signal in which a right-rear channel signal and the center channel signal are mixed may be outputted from a right speaker.

The electronic apparatus 100, based on information on an audio output type of an internal speaker equipped within the electronic apparatus 100 and information on an audio output type of an external speaker of the audio output apparatus 200, mixes at least two different channel signals among different channel signals included in the received audio signal, and assigns the mixed signal to each speaker.

Therefore, different mixed audio signals are outputted from each of the internal speaker of the electronic apparatus 100 included in an audio system 1000 and the external speaker of the audio output apparatus 200, and the audio system 1000 according to an exemplary embodiment may provide various multi-channel audio output environments.

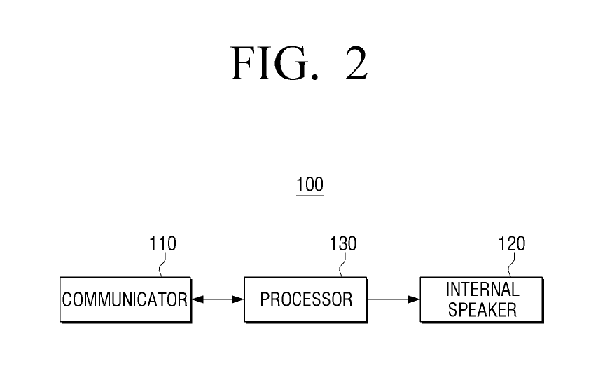

FIG. 2 is a block diagram illustrating a configuration of an electronic apparatus according to an exemplary embodiment.

Referring to FIG. 2, the electronic apparatus 100 includes a communicator 110, an internal speaker 120 and a processor 130.

The communicator 110 communicates with the audio output apparatus 200. Herein, the communicator 110 may communicate with an external speaker in various communication methods such as Bluetooth (BT), Wireless Fidelity (WI-FI), Zigbee, Infrared (IR), Serial Interface, Universal Serial Bus (USB), Near Field Communication (NFC), and the like.

Specifically, when a pre-set event occurs, the communicator 110 communicates with the audio output apparatus 200 according to a communication method pre-determined with the audio output apparatus 200 and may be connected with the audio output apparatus 200. Herein, the connection may indicate all conditions in which communications are possible such as a communication initialization between the electronic apparatus 100 and the audio output apparatus 200, a network forming operation, an apparatus pairing operation, and the like. For example, apparatus identification information of the audio output apparatus 200 may be provided to the electronic apparatus 100, and accordingly, the audio output apparatus 200 and the electronic apparatus 100 may be paired. For example, when a pre-set event occurs, the electronic apparatus 100 may search the adjacent audio output apparatus 200 through Digital Living Network Alliance (DLNA) technology, may perform pairing with the searched audio output apparatus 200, and may be connected to the audio output apparatus 200. Also, when a pre-set event occurs, the audio output apparatus 200 may search the adjacent electronic apparatus 100 through Digital Living Network Alliance (DLNA) technology, may perform pairing with the searched electronic apparatus 100 and may be connected with the electronic apparatus 100.

The communicator 110 may communicate with an external speaker in a wireless communication method which is a time division multiplexing method synchronizing wireless signal output time. Herein, the time division multiplexing method is a method by dividing data transmission time of various wireless channels by a certain time period and sequentially distributing the divided time period to each wireless channel. In other words, under the time division multiplexing method, since data transmission time is divided and transmitted by a certain time period, no interruption among data occurs.

Therefore, since the communicator 110 transmits a signal by using the wireless communication method of the time division multiplexing method, wireless channels do not overlap and a wireless interruption may be prevented.

In addition to the time division multiplexing method, the communicator 110 may transmit a signal through another wireless communication method and may communicate with an external speaker in a wired communication method.

The internal speaker 120 outputs a front channel signal and a center channel signal among the signals separated by the processor 130. Specifically, a left speaker in the internal speaker 120 may output a signal in which a left-front channel signal and the center channel signal are mixed and a right speaker of the internal speaker 120 may output a signal in which a right-front channel signal and the center channel signal are mixed.

The internal speaker 120 may include a right speaker, a left speaker and a center speaker, and in this case, the left speaker may output a left-front channel signal, the right speaker may output a right-front channel signal and the center speaker may output a center channel signal.

The explanation is based on the assumption that the internal speaker 120 includes two or three speakers. However, the internal speaker 120 is not limited thereto and may include four or more speakers.

The processor 130 controls overall operations of the electronic apparatus 100.

When a multi-channel audio signal is received, the processor 130 may assign different channel signals included in the multi-channel audio signal respectively to the internal speaker 120 and the external speaker. In this case, the processor 130 may separate different channel signals from the multi-channel audio signal by decoding the multi-channel audio signal and may assign the separated different channel signals to the internal speaker and the external speaker.

Based on the number of the internal speaker 120 and the external speaker, the processor 130 may assign a signal in which at least two different channel signals are mixed to each speaker. For example, if there are two internal speakers 120 and two external speakers, the processor 130 may assign a signal in which a left-front channel signal and a center channel signal are mixed and a signal in which a right-front channel signal and the center channel signal are mixed respectively to right and left speakers included in the internal speaker 120, and assign a signal in which a left-rear channel signal and the center channel signal are mixed and a signal in which a right-rear channel signal and the center channel signal are mixed respectively to right and left speakers included in the external speaker. In this case, since the respective right and left speakers included in the internal speaker 120 and the external speaker output respectively different mixed audio signals, a 5.1 channel audio output environment may be provided.

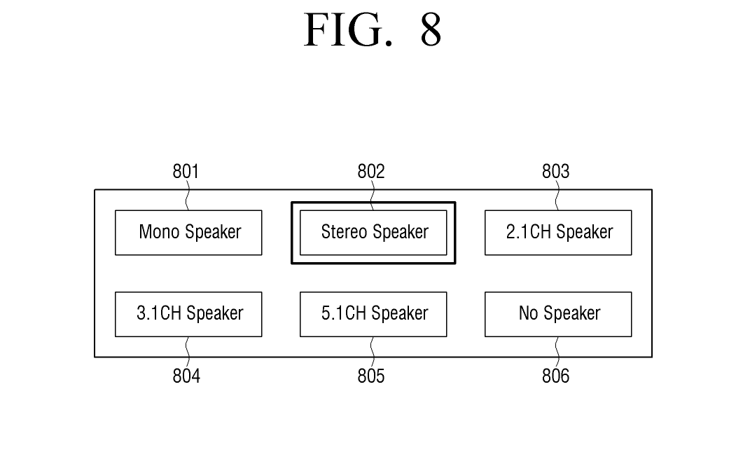

The processor 130 may mix at least two different channel signals based on information on an audio output type of the internal speaker 120 equipped within the electronic apparatus 100 and information on an audio output type of the external speaker and assign the mixed signal to each speaker. In this case, the processor 130 may provide a user interface (UI) for a user to select an audio output type(s) of the internal speaker 120 and the external speaker, and provide an UI regarding a providable audio output environment. A detailed UI configuration will be described later with reference to FIGS. 8 to 11.

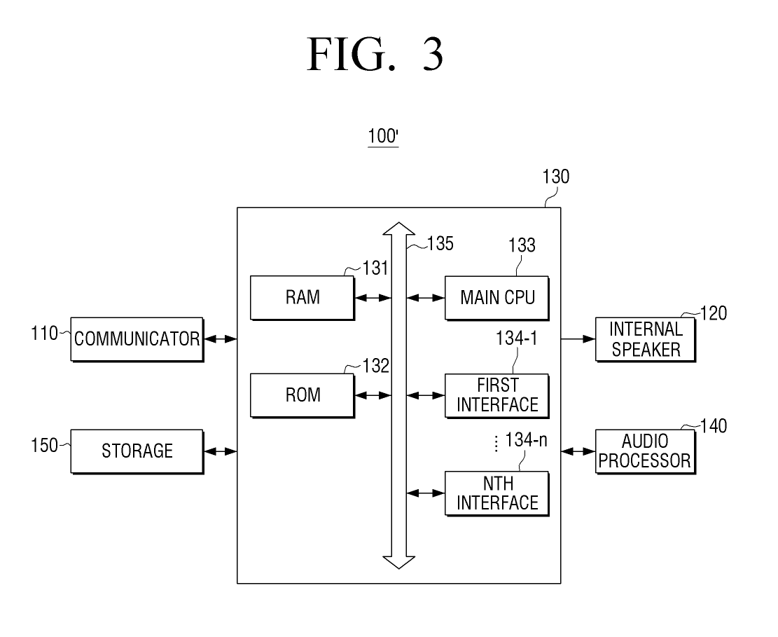

FIG. 3 is a block diagram illustrating a detailed configuration of an electronic apparatus illustrated in FIG. 2.

Referring to FIG. 3, an electronic apparatus 100′ includes the communicator 110, the internal speaker 120, the processor 130, an audio processor 140 and a storage 150. A detailed explanation on a configuration of FIG. 3 overlapping the configuration of FIG. 2 is omitted.

The processor 130 controls overall operations of the electronic apparatus 100′.

Specifically, the processor 130 includes a random access memory (RAM) 131, a read only memory (ROM) 132, a main central processing unit (CPU) 133, first to nth interfaces 134-1 to 134-n and a bus 135.

The RAM 131, the ROM 132, the main CPU 133, the first to nth interfaces 134-1 to 134-n may be connected to each other by the bus 135.

The first to nth interfaces 134-1 to 134-n are connected to the above-described various components. One of the interfaces may be a network interface which is connected to an external apparatus through the network.

The main CPU 133 accesses the storage 150 and carries out booting by using an operating system (O/S) stored in the storage 150. Also, the main CPU 133 executes various operations by using various programs, contents, data and the like stored in the storage 150.

In the ROM 132, a command set for booting a system is stored. When power is provided by a turn-on command being input, the main CPU 133 copies the O/S stored in the storage 150 according to the command stored in the ROM 132 and boots up the system by executing the O/S. When the booting is completed, the main CPU 133 copies various application programs stored in the storage 150 in the RAM 131 and carries out various operations by executing the copied application programs.

The audio processor 140 processes an audio signal. Specifically, the audio processor 140 may separate different channel signals from a multi-channel audio signal by decoding the multi-channel audio signal.

The storage 150 stores various data such as an O/S software module for operating the electronic apparatus 100′ and various multimedia contents.

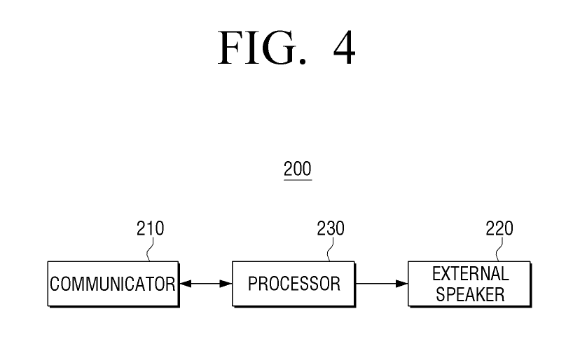

FIG. 4 is a block diagram illustrating a configuration of an audio output apparatus according to an exemplary embodiment.

Referring to FIG. 4, the audio output apparatus 200 includes a communicator 210, an external speaker 220 and a processor 230.

The communicator 210 communicates with the electronic apparatus 100 and receives an audio signal which is assigned from the electronic apparatus 100.

The external speaker 220 outputs a rear channel signal and a center signal among the signals assigned from the electronic apparatus 100. Specifically, a left speaker of the external speaker 220 may output a signal in which a left-rear channel signal and a center channel signal are mixed and a right speaker of the external speaker 220 may output a signal in which a right-rear channel signal and the center channel signal are mixed.

The external speaker 120 may include a right speaker, a left speaker and a center speaker, and in this case, the left speaker may output a left-rear channel signal, the left speaker may output a right-rear channel signal, and the center speaker may output a center channel signal.

The processor 230 controls the audio signal assigned from the electronic apparatus 100 through the communicator 210 to be outputted from the external speaker 220.

When a multi-channel audio signal is received, the processor 230 may control different channel signals to be output from each of the right and left speakers by assigning different channel signals included in the multi-channel audio signal respectively to the right and left speakers included in the external speaker 220.

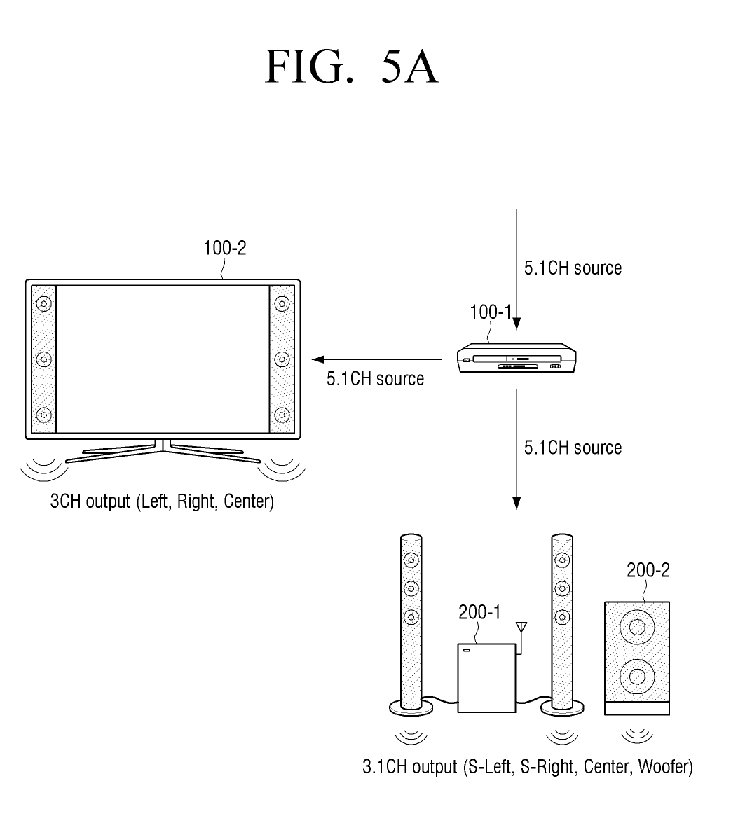

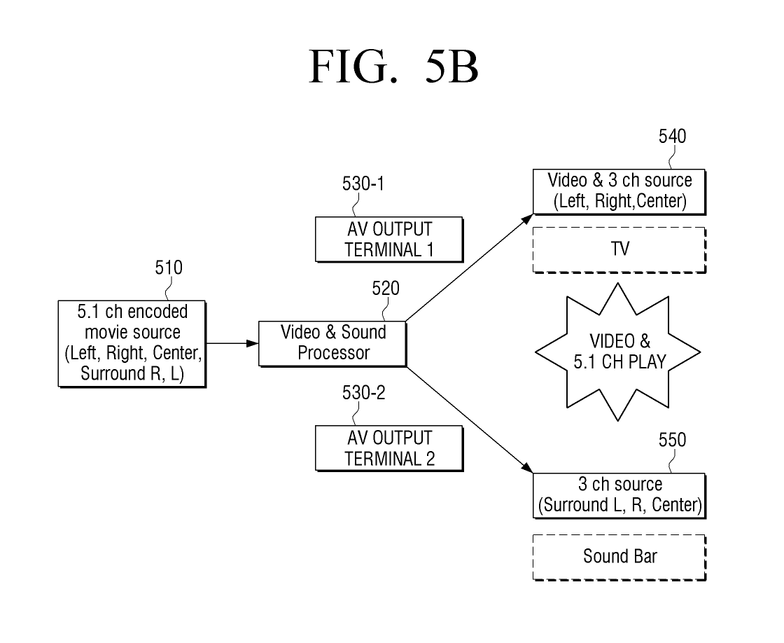

FIGS. 5A and 5B are views for explaining a method of embodying a 5.1 channel audio output from an electronic apparatus of a stereo output type and an audio output apparatus of a 2.1 channel type according to an exemplary embodiment.

According to an exemplary embodiment, electronic apparatuses 100-1 and 100-2 may be provided in one apparatus or may be provided in separated two apparatuses as illustrated in FIG. 5A.

For example, the electronic apparatuses 100-1 and 100-2 may have an audio output type of a stereo output and audio output apparatuses 200-1, 200-2 may have an audio output type of a 2.1 channel output.

In this case, when the electronic apparatuses 100-1 and 100-2 receive a multi-channel audio signal of a 5.1 channel type, the electronic apparatuses 100-1 and 100-2 may mix different channel signals by considering an audio output type of the internal speaker equipped within the electronic apparatuses 100-1 and 100-2 and an audio output type of the audio output apparatuses 200-1, 200-2, and assign the mixed signal to each speaker.

Specifically, since the internal speakers equipped within the electronic apparatuses 100-1 and 100-2 have an audio type of a stereo output, a signal in which a left-front channel signal and a center cannel signal are mixed and a signal in which a right-front channel signal and the center channel signal are mixed may be assigned; and since the external speakers equipped within the audio output apparatuses 200-1 and 200-2 have an audio type of 2.1 channel, a signal in which a left-rear channel signal and the center channel signal are mixed, a signal in which a right-rear channel signal and the center channel signal are mixed, and a woofer signal may be assigned.

In this case, respectively different audio signals are output from a right speaker and a left speaker included in the internal speaker equipped within the electronic apparatuses 100-1 and 100-2, a right speaker, a left speaker and the woofer speaker included in the external speaker equipped within the audio output apparatuses 200-1 and 200-2, and the 5.1 channel audio output environment may be provided to a user.

Referring to FIG. 5B, for example, when 5.1 channel encoded movie source 510 is input, a video and sound processor 520 of the electronic apparatus 100 may separate and mix movie source channels based on a TV and a sound apparatus, and provide the mixed signal to each of the TV and the sound apparatus. In this case, a signal may be transmitted by using audio/video (AV) output terminals 530-1 and 530-2, a video signal and a front 3-channel source (left, right, center) may be transmitted to the TV, and a rear 3-channel source (surround L, surround R, center) may be transmitted to the sound apparatus.

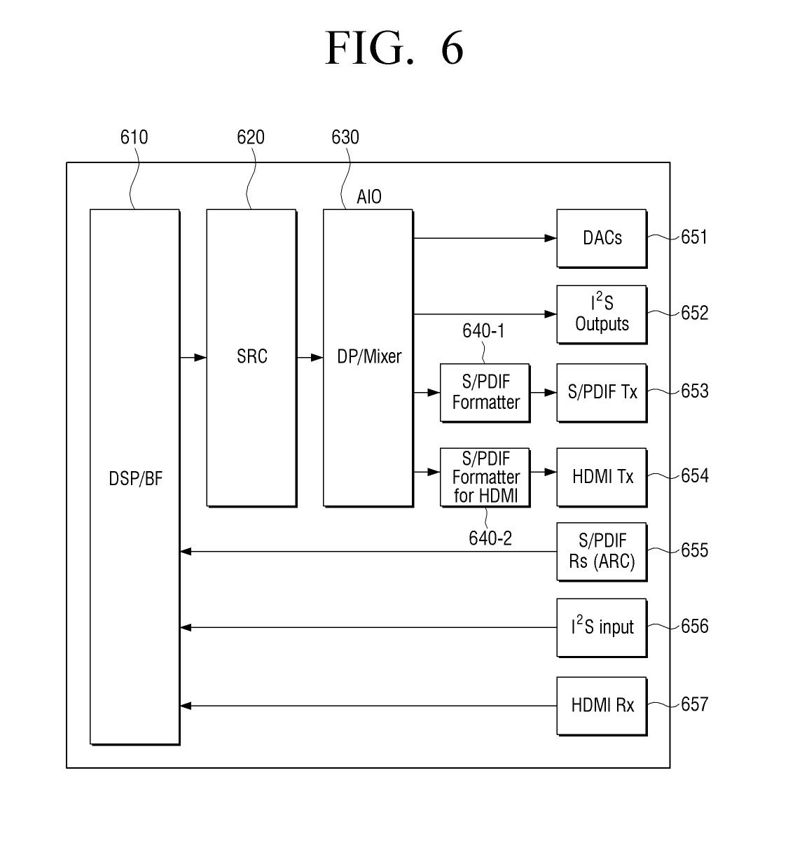

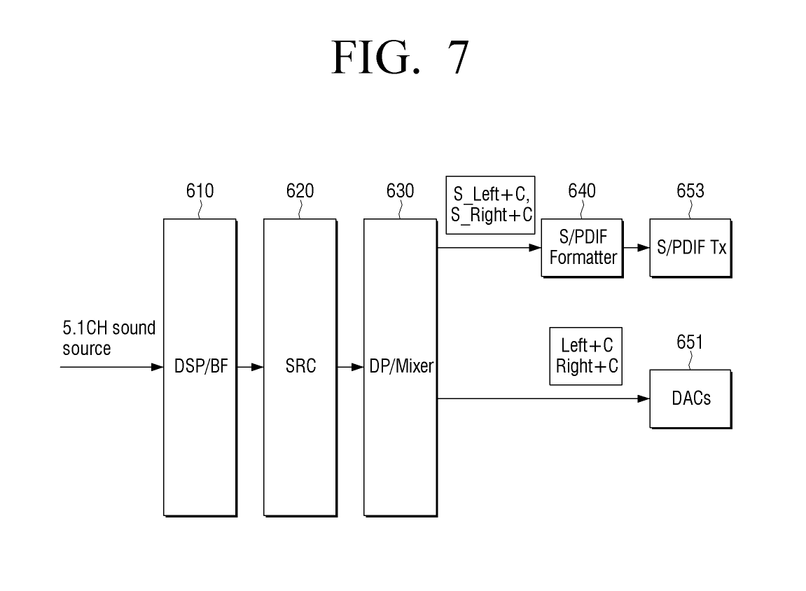

FIGS. 6 and 7 are block diagrams for explaining a method of assigning different channel signals from an electronic apparatus to each speaker according to an exemplary embodiment.

Referring to FIG. 6, the electronic apparatus 100 may include DSP/BF 610, SRC 620, DP/Mixer 630, S/PDIF Formatter 640-1, S/PDIF Formatter for HDMI 640-2, DACs 651, I²S Outputs 652, S/PDIF Tx 653, HDMI Tx 654, S/PDIF Rs (ARC) 655, I²S input 656 and HDMI Rx 657.

For example, as shown in FIG. 7, it is assumed that 5.1 channel audio source is input to DSP/BF 610 and the 2.1 channel audio output apparatus 200 is input. In this case, the 5.1 channel audio source is decoded in DSP 610 and is separated to each stream. Each of a left-front channel signal, a right-front channel signal, a left-rear channel signal and a right-rear channel signal may be mixed with a center channel signal in DP/Mixer 630. By outputting a mixture of the left-front channel signal and the center channel signal and a mixture of the right-front channel signal and the center channel signal through the DAC terminal which is connected with the internal speaker 120 and by outputting a mixture of the left-rear channel signal and the center channel signal and a mixture of the right-rear channel signal and the center channel signal through the SPDIF output terminal which is connected with the audio output apparatus 200, the 5.1 channel audio output environment may be provided.

FIG. 8 is a view illustrating an UI for selecting an audio output type of an internal speaker according to an exemplary embodiment.

Referring to FIG. 8, the electronic apparatus 100 may provide an UI for a user to select an audio output type of the internal speaker 120 equipped within the electronic apparatus 100. Specifically, the UI may include at least one of a mono speaker 801, a stereo speaker 802, a 2.1 channel speaker 803, a 3.1 channel speaker 804, and a 5.1 channel speaker 805, or may not include any speaker.

For example, if an audio output type of the internal speaker 120 is the stereo type, a user may select the stereo speaker 802 item. In this case, the electronic apparatus 100 may recognize as the internal speaker 120 has the audio output type of the stereo output.

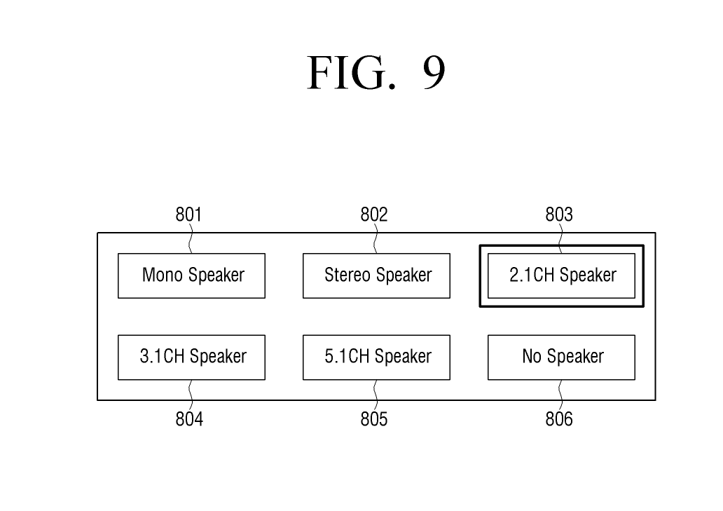

FIG. 9 is a view illustrating an UI for selecting an audio output type of an external speaker according to an exemplary embodiment.

Referring to FIG. 9, the electronic apparatus 100 may provide an UI for a user to select an audio output type of the external speaker 220 of the audio output apparatus 200. Specifically, the UI may include at least one of a mono speaker 801, a stereo speaker 802, a 2.1 channel speaker 803, a 3.1 channel speaker 804, and a 5.1 channel speaker 805, or may not include any speaker.

For example, if an audio output type of the external speaker 220 is a 2.1 channel audio output, a user may select the 2.1 channel speaker 803 item. In this case, the electronic apparatus 100 may recognize as the external speaker 220 has a 2.1 channel audio output type.

When audio output types of the internal speaker 120 and the external speaker 220 are recognized, the electronic apparatus 100 may mix at least two different channel signals based on information on the recognized audio output types.

Even though the explanation with reference to FIG. 8 and FIG. 9 is based on the limitation that audio output types of the internal speaker 120 and the external speaker 220 are selected by a user through an UI and the selected audio output types are recognized as audio output types of the internal speaker 120 and the external speaker 220, the exemplary embodiments are not limited thereto and the electronic apparatus 100 may directly recognize audio output types of the internal speaker 120 and the external speaker 220.

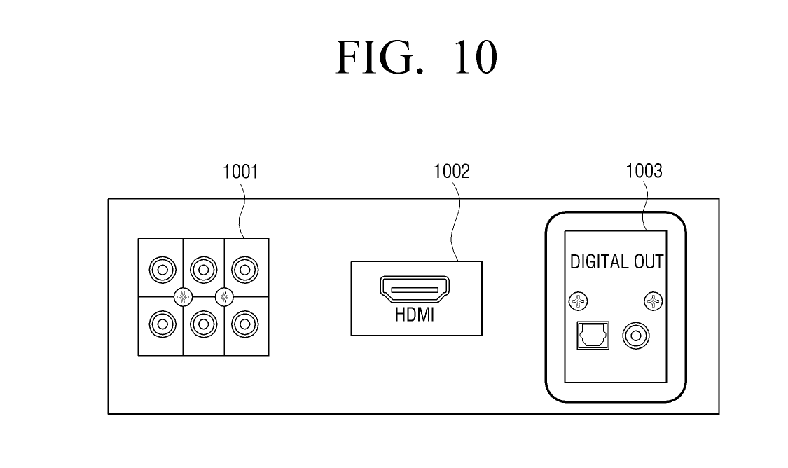

FIG. 10 is a view illustrating an UI for selecting a terminal connected to an external speaker according to an exemplary embodiment.

Referring to FIG. 10, the communicator 110 of the electronic apparatus 100 may communicate with the external speaker 220 in a wired communication method. In this case, the electronic apparatus 100 may provide an UI for a user to select a terminal connected to the external speaker 220. Specifically, the UI may include at least one item of the DAC 1001, HDMI 1002 and SPDIF 1003.

For example, if the electronic apparatus 100 is connected to the external speaker 220 by the SPDIF terminal, a user may select the SPDIF 1003 item. In this case, it may be recognized as the electronic apparatus 100 is connected with the external speaker 220 by the SPDIF terminal.

Even though the explanation with reference to FIG. 10 is based on the assumption that a terminal by which the electronic apparatus 100 and the external speaker 220 are connected is selected by a user through an UI and the selected terminal is recognized as a terminal by which the electronic apparatus 100 and the external speaker 220 are connected, the exemplary embodiments are not limited thereto, and the electronic apparatus 100 may directly recognize a terminal by which the electronic apparatus 100 and the external speaker 220 are connected.

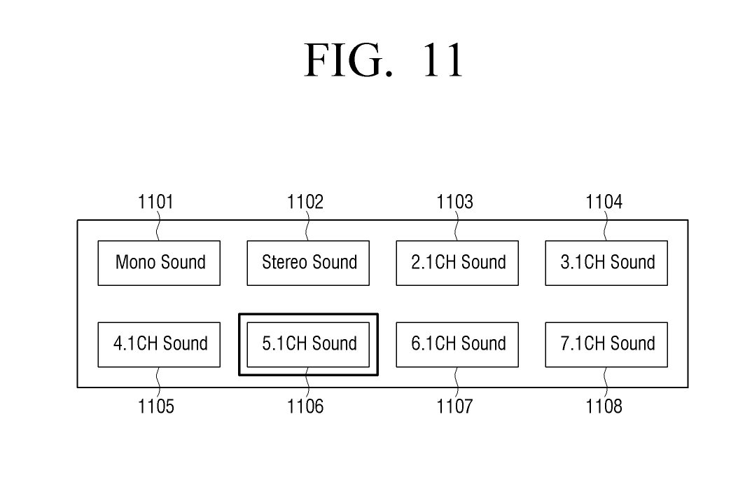

FIG. 11 is a view illustrating an UI for selecting a providable audio output environment according to an exemplary embodiment.

Referring to FIG. 11, the electronic apparatus 100 may provide an UI for a user to select a wanted audio output environment. Specifically, based on information on an audio output environment of the internal speaker 120 and the external speaker 220, the electronic apparatus 100 may provide an UI including information on a providable audio environment. In this case, the UI may include at least one of a mono sound 1101 item, a stereo sound 1102 item, a 2.1 channel sound 1103 item, a 3.1 channel sound 1104 item, a 4.1 channel sound 1105 item, a 5.1 channel sound 1106 item, a 6.1 channel sound 1107 item and a 7.1 channel sound 1108 item. Also, the exemplary embodiments are not limited thereto and the UI may include a channel sound item whose channel is 8.1 channel or higher than 8.1 channel.

For example, when the 5.1 channel sound is the audio output environment that a user wants, the user may select the 5.1 channel sound 1106 item. In this case, the electronic apparatus 100 may mix different channel signals to embody the audio output environment as the 5.1 channel sound, and may assign the mixed signal to each speaker.

Even though the explanation with reference to FIG. 11 is based on the limitation that a user selects a wanted audio output environment through an UI and the electronic apparatus 100 embody the user's selected audio output environment, the exemplary embodiments are not limited thereto, and the electronic apparatus 100 may determine an audio output environment itself and embody the determined audio output environment. For example, if the internal speaker 120 is a stereo audio output type and the external speaker 220 is a 2.1 channel audio output type, a 5.1 channel audio output environment may be automatically embodied and a multi-channel audio output environment (e.g., a multi-channel audio output environment having the greatest number of channels) among implementable audio output environments may be provided.

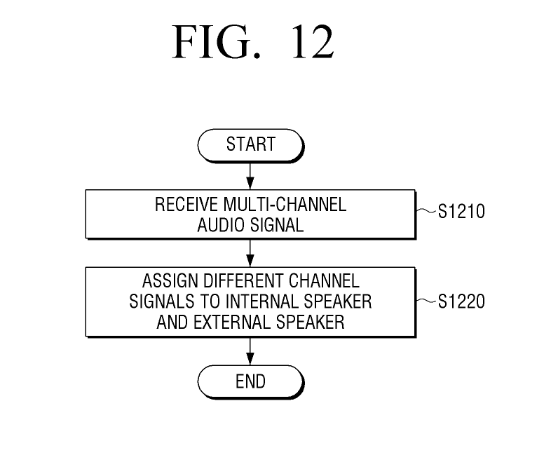

FIG. 12 is a view for explaining an audio output method of an electronic apparatus according to an exemplary embodiment.

According to an audio output method of the electronic apparatus 100 illustrated in FIG. 12, the electronic apparatus 100 receives a multi-channel audio signal (S1210). Herein, the multi-channel audio signal may include different channel signals.

When the electronic apparatus 100 receives the multi-channel audio signal, different channel signals included in the multi-channel audio signal are assigned to each speaker (S1220). Here, each speaker may be at least two speakers equipped within the electronic apparatus 100 or at least one external speaker equipped within the external output apparatus.

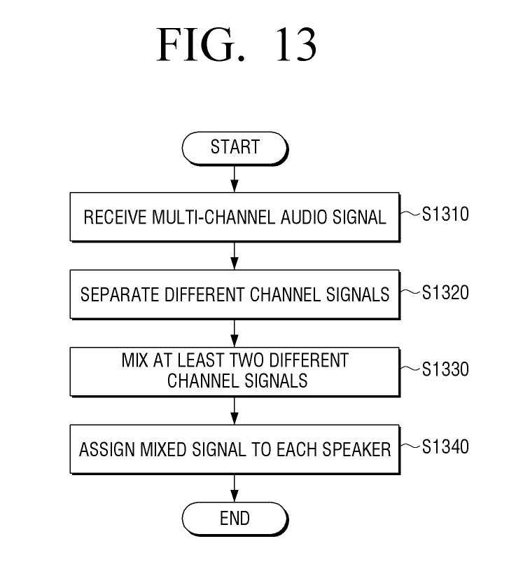

FIG. 13 is a view for explaining an audio output method of an electronic apparatus in detail according to an exemplary embodiment.

Referring to FIG. 13, the electronic apparatus 100 receives a multi-channel audio signal (S1310). Herein, the multi-channel audio signal may include different channel signals.

The electronic apparatus 100 decodes the multi-channel audio signal and separates different channel signals from the multi-channel audio signal (S1320).

The electronic apparatus mixes at least two different channel signals (S1330). In this case, based on the number of the internal speakers equipped within the electronic apparatus 100 and the external speaker equipped within the audio output apparatus, different channel signals may be mixed.

The electronic apparatus 100 assigns the mixed signal to each speaker (S1340).

In S1340, based on information on an audio output type of the internal speaker and information on an audio output type of the external speaker, the electronic apparatus 100 may mix at least two different channel signals and assign the mixed signal to each speaker.

Also, the audio output method may further include providing an UI for selecting at least one audio output type for the internal speaker and at least one audio output type for the external speaker.

Based on information on the audio output environment of the internal speaker and information on the audio output environment of the external speaker, the audio output method may further include providing an UI including information on at least one providable audio output environment.

According to the various exemplary embodiments of the exemplary embodiments are, when the electronic apparatus 100 is connected with the audio output apparatus 200, an audio output environment of channel which is not supported by the electronic apparatus 100 and the audio output apparatus 200 may be provided.

The methods according to the various exemplary embodiments may be embodied by only upgrading software of an existing electronic apparatus.

Also, a non-transitory computer readable medium in which a program sequentially executes audio output methods may be provided.

For example, provided is a non-transitory computer readable medium storing a program which executes receiving a multi-channel audio signal and, in response to the multi-channel audio signal being received, outing different channel signals through different speakers by assigning the different channel signals included in the multi-channel audio signal respectively to at least two internal speakers and at least one external speaker.

The non-transitory computer readable medium is not a medium that stores data for a short time such as a register, cache, and a memory, but it indicates a medium which can store data semi-permanently and a medium that an apparatus can read. Specifically, the above-described various applications or programs may be stored in a non-transitory computer readable medium such as a compact disc (CD), a digital versatile disc (DVD), a hard disk, a Blu-ray disk, a universal serial bus (USB), a memory card, a ROM and the like, and can be provided.

When the exemplary embodiments have been illustrated and described, it will be understood by those skilled in the art that various changes in form and details may be made therein without departing from the spirit and scope of the exemplary embodiments as defined by the appended claims.

What is claimed is:

1. An electronic apparatus comprising:
at least two internal speakers;
a communicator configured to communicate with at least one external speaker; and
a processor configured to, in response to a multi-channel audio signal being received, respectively assign different channel signals included in the multi-channel audio signal to the at least two internal speakers and the at least one external speaker so that the different channel signals are output through the at least two internal speakers and the at least one external speaker.

2. The apparatus as claimed in claim 1, further comprising:
an audio processor configured to process the multi-channel audio signal,
wherein the processor is further configured to separate the different channel signals from the multi-channel audio signal by decoding the multi-channel audio signal, mix at least two different channel signals among the separated different channel signals based on a number of the at least two internal speakers and the at least one external speaker, and assign the mixed signal to the at least two internal speakers and the at least one external speaker.

3. The apparatus as claimed in claim 2, wherein the processor is further configured to mix at least two different channel signals among the separated different channel signals based on information on an audio output type of the at least two internal speakers and information on an audio output type of the at least one external speaker, and assign the mixed signal to the at least two internal speakers and the at least one external speaker.

4. The apparatus as claimed in claim 3, wherein the processor is further configured to provide a user interface (UI) for selecting at least one of the audio output type of the at least two internal speakers and the audio output type of the at least one external speaker.

5. The apparatus as claimed in claim 4, wherein the processor is further configured to provide a UI including at least one piece of information on a providable audio output environment based on information on an audio output environment of the at least two internal speakers and information on an audio output environment of the at least one external speaker, mix at least two different channel signals among the separated different channel signals based on the selected audio output environment, and assign the mixed signal to the at least two internal speakers and the at least one external speaker.

6. The apparatus as claimed in claim 1,
wherein the multi-channel audio signal includes a front channel signal, a center channel signal and a rear channel signal,
wherein the processor is further configured to assign the front channel signal and the center channel signal to the at least two internal speakers, and assign the rear channel signal and the center channel signal to the at least one external speaker.

7. The apparatus as claimed in claim 6, wherein the at least one external speaker comprises two or more speakers, and
wherein the processor is further configure to assign, to a right speaker and a left speaker which are included in the at least two internal speakers, a signal in which a left-front channel signal and the center channel signal are mixed and a signal in which a right-front channel signal and the center channel signal are mixed, and assign, to a right speaker and a left speaker which are included in the at least one external speaker, a signal in which a left-rear channel signal and the center channel signal are mixed and a signal in which a right-rear channel signal and the center channel signal are mixed.

8. The apparatus as claimed in claim 1, wherein the communicator is further configure to communicate with the at least one external speaker in a wireless communication method by using time division multiplexing, which synchronizes wireless signal output time.

9. The apparatus as claimed in claim 1,
wherein the communicator is further configure to communicate with the at least one external speaker in a wired communication method, and
wherein the processor is further configure to assign the multi-channel audio signal to the at least one external speaker based on information on a terminal which is connected to the at least one external speaker.

10. An audio system comprising:
an electronic apparatus comprising at least two first speakers; and
an audio output apparatus configured to communicate with the electronic apparatus and comprises at least one second speaker,
wherein the electronic apparatus is configured to, in response to a multi-channel audio signal being received, respectively assign different channel signals included in the multi-channel audio signal to the at least two first speakers and the at least one second speaker so that the different channel signals are output through the at least two first speakers and the at least one second speaker.

11. The system as claimed in claim 10, wherein the electronic apparatus is further configure to separate the different channel signals from the multi-channel audio signal by decoding the multi-channel audio signal, mix at least two different channel signals among the separated different channel signals based on a number of the at least two first speakers and the at least one second speaker, and assign the mixed signal to the at least two first speakers and the at least one second speaker.

12. An audio output method of an electronic apparatus that comprises at least two internal speakers and communicates with at least one external speaker, the method comprising:
receiving a multi-channel audio signal; and
respectively assigning, in response to the multi-channel audio signal being received, different channel signals included in the multi-channel audio signal to the at least two internal speakers and the at least one external speaker so that different channel signals are output through the at least two internal speakers and the at least one external speaker.

13. The method as claimed in claim 12, wherein the assigning comprises separating the different channel signals from the multi-channel audio signal by decoding the multi-channel audio signal, mixing at least two different channel signals among the separated different channel signals based on a number of the at least two internal speakers and the at least one external speaker, and assigning the mixed signal to the at least two internal speakers and the at least one external speaker.

14. The method as claimed in claim 13, wherein the assigning comprises mixing at least two different channel signals among the separated different channel signals based on information on an audio output type of the at least two internal speakers and information on an audio output type of the at least one external speaker, and assigning the mixed signal to the at least two internal speakers and the at least one external speaker.

15. The method as claimed in claim 14, further comprising providing a user interface (UI) for selecting at least one of the audio output type of the at least two internal speakers and the audio output type of the at least one external speaker.

16. The method as claimed in claim 14, further comprising providing an UI including at least one piece of information on a providable audio output environment based on information on an audio output environment of the at least two internal speakers and information on an audio output environment of the at least one external speaker,
wherein the assigning comprises mixing at least two different channel signals among the separated different channel signals based on the selected audio output environment, and assigning the mixed signal to the at least two internal speakers and the at least one external speaker.

17. The method as claimed in claim 12, wherein the multi-channel audio signal comprises a front channel signal, a center channel signal and a rear channel signal, and
wherein the assigning comprises assigning the front channel signal and the center channel signal to the at least two internal speakers, and assigning the rear channel signal and the center channel signal to the at least one external speaker.

18. The method as claimed in claim 17, wherein the at least one external speaker comprises two or more speakers, and
wherein the assigning comprises assigning, to a right speaker and a left speaker which are included in the at least two internal speakers, a signal in which a left-front channel signal and the center channel signal are mixed and a signal in which a right-front channel signal and the center channel are mixed, and assigning, to a right speaker and a left speaker which are included in the at least one external speaker, a signal in which a left-rear channel signal and the center channel signal are mixed and a signal in which a right-rear channel signal and the center channel signal are mixed.

19. The method as claimed in claim 12, wherein the receiving comprises receiving the multi-channel audio signal in a wireless communication method by using time division multiplexing, which synchronizes wireless signal output time.

20. The method as claimed in claim 12, wherein the receiving comprises receiving the multi-channel audio signal in a wired communication method, and
wherein the assigning comprises assigning the multi-channel audio signal to the at least one external speaker based on information on a terminal which is connected with the at least one external speaker.
